(19) United States
(12) Patent Application Publication
(10) Pub. No.: US 2003/0031418 A1
(43) Pub. Date: Feb. 13, 2003

(54) Ball grid array element and optical communication module using the same

(76) Inventor: Satoshi Yoshikawa, Kanagawa (JP)

Correspondence Address: MCDERMOTT, WILL & EMERY, 600 13th Street, N.W., Washington, DC, 20005-3096, US

(21) Appl. No.: 10/209,666

(22) Filed: Aug. 1, 2002

(30) Foreign Application Priority Data
Aug. 1, 2001 (JP) P. 2001-233646

(51) Int. Cl. G02B 6/36; G02B 6/42

(52) U.S. Cl. 385/53; 385/88

(57) ABSTRACT

A ball grid array (BGA) element comprises a bottom surface having the BGA consisting of a plurality of solder balls thereon, and an upper surface opposed to the bottom surface and having connector terminals consisting of any one of plural plugs or plural receptacles, which are connected to the solder balls respectively individually, thereon. The BGA element further comprises supporting portions that are brought into contact with a predetermined mounting surface when the BGA element is surface-mounted on the predetermined mounting surface, to define an interval between the BGA element and the predetermined mounting surface.

### BACKGROUND OF THE INVENTION

1. Field of the Invention

The present invention relates to a ball grid array (referred to as a “BGA” hereinafter) element and an optical communication module using the same.

2. Description of the Related Art

As the BGA element, there is such an element that has the BGA consisting of a plurality of solder balls on its bottom surface and has connector terminals consisting of any one of plural plugs or plural receptacles on its upper surface that opposes to the bottom surface. The any one of plural plugs or plural receptacles are connected to the solder balls individually and respectively. When the BGA element is surface-mounted onto a circuit board having a wiring circuit, etc., such BGA element functions as connector terminals that are highly integrated on the circuit board. Here, in the BGA element, any one of plural plugs or plural receptacles are highly integrated at the pitch of about 1 to 1.5 mm, for example. Therefore, when the BGA element is coupled to another BGA element that has the connector terminals consisting of the other of plural corresponding plugs or plural corresponding receptacles, the fitting length range between the plugs and the receptacles is restricted to 0.5 mm, for example.

The surface-mounting of the BGA element onto the circuit board is executed by melting the solder balls. In this case, the solder-connected portion between the BGA element and the circuit board, which is formed by melting the solder balls, is weak against the mechanical stress. Similarly, the fitted portions between the plugs and the receptacles of the BGA element and another BGA element are weak against the mechanical stress. Therefore, in order to avoid the application of the excessive mechanical stress to the solder-connected portion and the fitted portions, another BGA element has a contact portion that comes into contact with the circuit board and supports another element against the circuit board at the position at which the connector terminals of the BGA element are fitted to the connector terminals of another BGA element within the predetermined fitting length range.

Therefore, when the BGA element is surface-mounted onto the circuit board, it is important that, even after the solder balls are melted, the position of the BGA element, particularly the position of the connector terminals of the BGA element, should be set to the position, which is defined previously prior to the melting of the solder balls, in the direction perpendicular to the mounting surface of the circuit board on which the BGA element is surface-mounted.

Meanwhile, the melting of the solder balls is carried out in a furnace by a reflow process for about 1 to 2 minutes in the atmosphere at 210° C. to 225° C. in the situation that the BGA element is put on the circuit board to which the surface-mounting is applied. The melting characteristic of the solder balls are changed according to the variations in the temperature distribution in the furnace, in which the reflow process is applied, and the conditions such as the reflow process time, etc. Therefore, it is substantially difficult to manage always the melting characteristic of the solder balls within a certain range. According to the experiment made by the inventor of this application, in some cases the position of the connector terminals of the BGA element against the circuit board is shifted from the previously-defined position by 0.2 to 0.3 mm after the solder balls are melted. As a result, in the situation that the position of the connector terminals of the BGA element against the circuit board is shifted close to the circuit board side rather than the previously-defined position after the solder balls are melted, when the connector terminals of the BGA element are fitted into the connector terminals of another BGA element, sometimes the fitting between the connector terminals of the BGA element and the connector terminals of another BGA element cannot be properly attained even if the contact portions of another BGA element come into contact with the circuit board and are supported by the circuit board. Also, in the situation that the position of the connector terminals of the BGA element against the circuit board is shifted far from the circuit board side rather than the previously-defined position after the solder balls are melted, sometimes the contact portions of another BGA element do not come into contact with the circuit board even if the connector terminals of the BGA element and the connector terminals of another BGA element are fitted properly within the fitting length range. In order to avoid these situations, it is possible to employ the method of manufacturing another BGA element while referring to the result of each surface-mounting of the BGA element so that another BGA element can correspond to the result of the surface-mounting after the BGA element is surface-mounted onto the circuit board. However, such manufacturing method needs complicated steps and also the improvement in the productivity is restricted.

Then, there is an optical communication module that employs the BGA element as the input/output terminal of the electric signals. The optical communication module comprises at least any one of a light transmitting module or a light receiving module, a semiconductor circuit element, a circuit board, and a housing. At least any one of the light transmitting module or the light receiving module and the semiconductor circuit element are mounted onto the circuit board and are contained in the housing. Further, the optical communication module further comprises the BGA element used as the input/output terminal of the electric signals on the circuit board. Therefore, in such optical communication module, the similar problem appears in the surface-mounting of the BGA element onto the circuit board.

### SUMMARY OF THE INVENTION

Therefore, it is an object of the present invention to provide a BGA element and an optical communication module using the BGA element, a position of connector terminals of which against a circuit board after a surface-mounting can coincide with a position defined previously before the surface-mounting and which makes it possible to carry out the manufacture of another GBA element, which contacts to the circuit board on which the BGA element is surface-mounted, to define a fitting length between the BGA element and another BGA element, independently from the surface-mounting of the BGA element onto the circuit board.

In order to accomplish the object above, the following means are adopted. According to the present invention, there is provided a BGA element comprising: a main body portion having a bottom surface and an upper surface opposed to the bottom surface, the bottom surface having a ball grid array including a plurality of solder balls thereon, the upper surface having connector terminals connected respectively individually to the solder balls thereon; and a supporting portion for defining an interval between the ball grid array element and a mounting surface on which the ball grid array element is surface-mounted, the supporting portion being brought into contact with the mounting surface when the ball grid array element is surface-mounted.

According to the above-mentioned BGA element of the present invention, the interval between the BGA element and the mounting surface on which the BGA element is surface-mounted after the BGA element is surface-mounted is defined by the supporting portions. Therefore, the position of the connector terminals provided to the BGA element against the mounting surface can be set to the position, which is defined previously by the supporting portions prior to the surface-mounting of the BGA element, without the influence of the change in the environmental conditions in the surface-mounting. As a result, the manufacture of another BGA element, which has the connector terminals that are fitted to the connector terminals of the BGA element and comes into contact with the mounting surface on which the BGA element is surface-mounted to define the fitting length into the BGA element, can be carried out independently from the surface-mounting of the BGA element, by referring to the interval between the connector terminals of the BGA element and the mounting surface, which is defined by the supporting portions.

Preferably, the above-mentioned BGA element of the present invention further comprises a contact portion for defining a fitting length range of the connector terminals of the ball grid array element and another connector terminals of another ball grid array element to be connected to the ball grid array element, the contact portion being brought into contact with another mounting surface on which another ball grid array element is surface-mounted when the ball grid array element is connected to another ball grid array element. The connector terminals of the ball grid array element includes one of a plurality of plugs and a plurality of receptacles, and another connector terminals of another ball grid array element includes the other of a plurality of plugs and a plurality of receptacles.

According to the above-mentioned BGA element of. the present invention, the BGA element, which is surface-mounted on the mounting surface, is supported by the contact portion at the position that is defined to attain the fitting with another BGA element, which includes any other of plural plugs or plural receptacles, within the fitting length range. Therefore, when the BGA element is pushed against another mounting surface and is fixed thereto, such pushing/fixing operation does not directly apply the mechanical stress to the fitted portions of the connector terminals, which are fitted within the fitting length range, and the solder-connected portions between the another mounting surface and another BGA element with the connector terminals including any other of plural plugs or plural receptacles.

In order to accomplish the object above, the following means are adopted. According to the present invention, there is provided an optical communication module comprising: at least one of a light transmitting module and a light receiving module; at least one semiconductor circuit element used for at least one of light transmitting module and the light receiving module; a ball grid array element including a main body portion having a bottom surface and an upper surface opposed to the bottom surface, the bottom surface having a ball grid array including a plurality of solder balls thereon, the upper surface having connector terminals connected respectively individually to the solder balls thereon, and a supporting portion for defining an interval between the ball grid array element and a mounting surface on which the ball grid array element is surface-mounted, the supporting portion being brought into contact with the mounting surface when the ball grid array element is surface-mounted; a circuit board on which at least one of the light transmitting module and the light receiving module, at least one semiconductor circuit element, and the ball grid array element are provided; and a housing for containing the circuit board.

According to the above-mentioned optical communication module of the present invention, the manufacture of another BGA element, which is fitted to the connector terminals of the BGA element provided to the optical communication module, can be carried out independently from the surface-mounting of the BGA element onto the circuit board, by referring to the interval between the connector terminals of the BGA element and the circuit board, which is defined by the supporting portions.

Preferably, in the above-mentioned optical communication module of the present invention, the housing has a housing bottom surface which is brought into contact with another mounting surface on which another ball grid array element having another connector terminals is surface-mounted when the optical communication module is mounted on another mounting surface. The connector terminals of the ball grid array element includes one of a plurality of plugs and a plurality of receptacles, and another connector terminals of another ball grid array element includes the other of a plurality of plugs and a plurality of receptacles.

According to the above-mentioned optical communication module of the present invention, the BGA element can be supported by the housing bottom portion at the position that is defined to attain the fitting with another connector terminals of another BGA element, which is surface-mounted on another mounting surface, within the fitting length range. Therefore, when the optical communication module is pushed against another mounting surface and is fixed thereto, such pushing/fixing operation does not directly apply the mechanical stress to the fitted portions of the connector terminals, which are fitted within the fitting length range, and the solder-connected portions between the another mounting surface and another BGA element with the connector terminals including of any other of plural plugs or plural receptacles.

### BRIEF DESCRIPTION OF THE DRAWINGS

FIG. 1A is a perspective view of a first embodiment of a BGA element according to the present invention, which is viewed from the top;

FIG. 1B is a perspective view of the first embodiment of the BGA element according to the present invention, which is viewed from the bottom;

FIG. 1C is a sectional view of the first embodiment of the BGA element taken along a Z-Z′ direction in FIG. 1A;

FIG. 2 is a sectional view of the state after a BGA element 1 according to the present embodiment is surface-mounted onto a circuit board 3;

FIG. 3 is a sectional view of the state that the circuit board 3, onto which the BGA element 1 according to the present embodiment is surface-mounted, is connected to another circuit board 7, onto which another BGA element 5 according to the present embodiment is surface-mounted, via respective connector terminals of the BGA element 1 and another BGA element 5;

FIG. 4A is a perspective view of a second embodiment of the BGA element according to the present invention, viewed from the bottom;

FIG. 4B is a perspective view of a third embodiment of the BGA element according to the present invention, viewed from the bottom;

FIG. 5A is a perspective view of an optical communication module 8 using the BGA element according to the present invention, which is viewed obliquely from the top;

FIG. 5B is a perspective view of the optical communication module 8 using the BGA element according to the present invention, which is viewed obliquely from the bottom;

FIG. 5C is a sectional view of the optical communication module 8 taken along a Y-Y′ direction in FIG. 5A; and

FIG. 6 is side sectional view of the state that the optical communication module 8 is mounted on a mounting board 9.

### DETAILED DESCRIPTION OF THE INVENTION

Next, an embodiment of a BGA element according to the present invention will be explained with reference to the accompanying drawings hereinafter. The redundant explanation will be omitted hereunder by affixing the same symbols to the same elements.

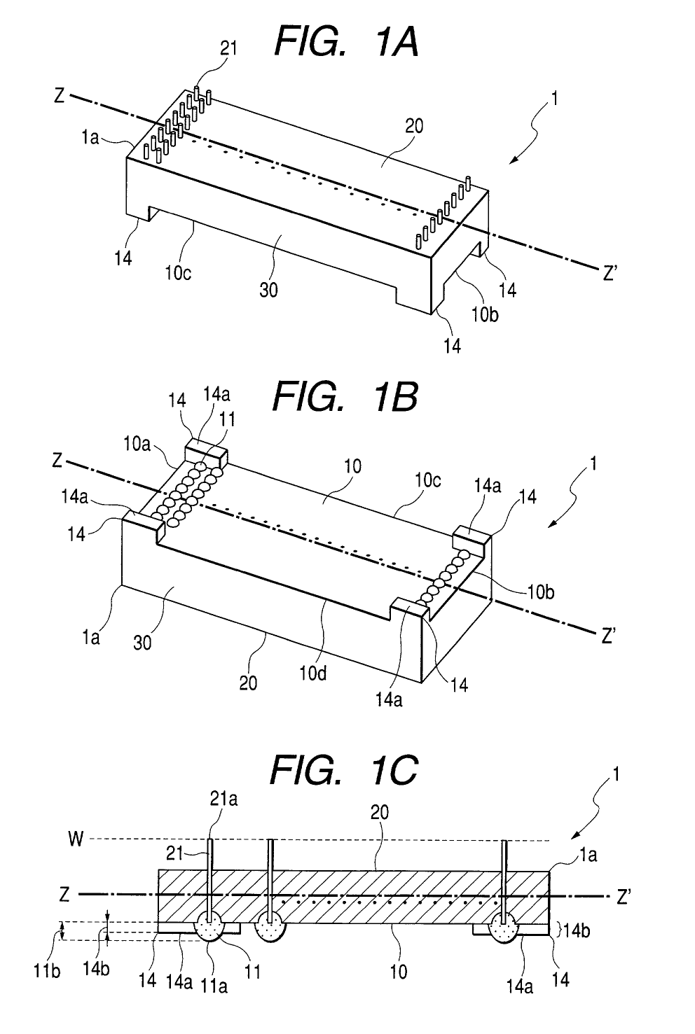

FIG. 1A shows a perspective view of a first embodiment of a BGA element according to the present invention, which is viewed from the top. FIG. 1B shows a perspective view of the first embodiment of the BGA element according to the present invention, which is viewed from the bottom. FIG. 1C shows a sectional view of the first embodiment of the BGA element according to the present invention taken along a Z-Z′ direction in FIG. 1A.

A BGA element 1 has an almost rectangular parallelepiped shape, and has a main body portion 1a. The main body portion 1a has a bottom surface 10, an upper surface 20 opposing to the bottom surface 10, and side surfaces 30 connected to the bottom surface 10 and the upper surface 20. The main body portion 1a is formed of insulating material. Then, 240 solder balls 11 having an equal size mutually (referred to as “plural solder balls” hereinafter) are provided to the bottom surface 10 of the main body portion 1a such that 8 balls are aligned in parallel at an interval of 1.27 mm along the direction, which is in parallel with the sides 10a, 10b as short sides of the bottom surface 10, and 30 balls are aligned in parallel at the same interval along the direction, which is in parallel with the sides 10c, 10d as long sides of the bottom surface 10, whereby the BGA is constructed. Pin-type plugs 21 made of metal material are extended from the plural solder balls 11 toward the upper surface 20 and then projected from the upper surface 20 respectively such that the plugs are connected individually to respective solder balls 11 and also are positioned perpendicularly to the bottom surface 10 respectively. Then, all lengths of top ends 21a of the plugs 21, which are projected from the upper surface 20, are equally set mutually, and also all top ends 21a of plural plugs 21 are positioned on the W plane that is set in parallel with the bottom surface 10. Plural plugs 21 constitute a multi-core male connector terminal.

In addition, supporting portions 14 are provided to four corners of the bottom surface 10 respectively. The supporting portions 14 have supporting surfaces 14a that are set in parallel with the bottom surface 10, and also supporting lengths 14b each of which is a distance between the bottom surface 10 and the supporting surfaces 14a. The supporting lengths 14 b are set respectively such that they become mutually equal. In other words, a flat plane that contains respective supporting surfaces 14a positioned at four corners is formed in parallel with a flat plane that contains the top ends 21a of the plugs 21. The supporting surfaces 14a are positioned close to the bottom surface 10 rather than top ends 11a of the solder balls 11. That is, the supporting lengths 14b are shorter than the solder ball lengths 11b which is a distance between the bottom surface 10 and the top ends 11a of the solder balls 11.

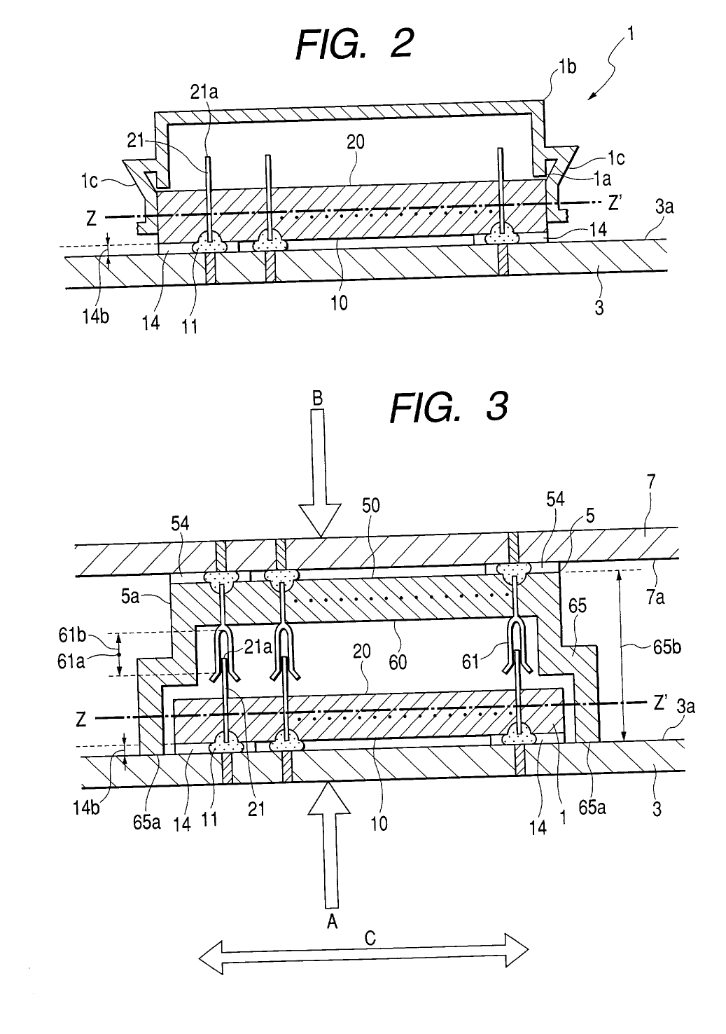

FIG. 2 is a sectional view of the state after the BGA element 1 is surface-mounted onto a circuit board 3.

The circuit board 3 has a mounting surface 3a onto which the BGA element 1 is surface-mounted, and also plural pads (not shown) that correspond to plural solder balls 11 being provided to the bottom surface 10 of the BGA element 1 respectively are provided to the mounting surface 3a. Then, when plural solder balls 11 are melted, the BGA element 1 and the circuit board 3 are solder-connected via plural solder balls 11 and plural corresponding pads respectively. Although the procedures of surface-mounting the BGA element 1 onto the mounting surface 3a will be explained hereunder, the bottom surface 10 of the BGA element 1 and the mounting surface 3a of the circuit board 3 are positioned in parallel and also an interval between the mounting surface 3a of the circuit board 3 and the bottom surface 10 of the BGA element 1 is defined by the supporting portions 14 of the BGA element 1. First, the BGA element 1 is positioned and mounted on the mounting surface 3a such that plural solder balls 11 provided to the bottom surface 10 are put on plural corresponding pads respectively. In this state, the BGA element 1 can be supported by bringing the top ends 11a of plural solder balls 11 into contact with the corresponding pads respectively. Here, another soldering material that is used to solder-connect the solder balls 11 together may be applied previously onto the pads. In this case, the electrical connection between the solder balls 11 and the pads can be improved more surely.

After the BGA element 1 is mounted onto the mounting surface 3a, the reflow process is carried out for about 1 to 2 minutes in the atmosphere at 210° C. to 225° C. to melt the solder balls 11 and then get the solder-connection to the pads. Then, in the reflow process, when the solder balls 11 are melted, the bottom surface 10 of the BGA element 1 comes gradually close to the mounting surface 3a of the circuit board 3 by its own weight of the BGA element 1 and thus the supporting portions 14a of the supporting portions 14, which are provided to four corners of the bottom surface 10, come into contact with the mounting surface 3a of the circuit board 3 respectively. Then, after the reflow process, the BGA element 1 is connected to the mounting surface 3a of the circuit board 3 by the solder in the situation that such BGA element 1 is supported by the supporting portions 14 positioned on four corners of the bottom surface 10. Here, since plural plugs 21 of the BGA element 1 are simply deformed by the weak mechanical external force that is applied from the outside, a cap 1b for protecting the plugs 21 may be provided further. The cap 1b has a temporarily-fixing means 1c that can be attached/detached to/from the main body portion 1a of the BGA element 1 and, as the case may be, can be fitted to the main body portion 1a after the reflow process. Here, since its own weight of the BGA element 1 is increased if the cap 1b is fitted in the reflow process, the supporting portions 14a of the supporting portions 14 can be brought into contact with the mounting surface 3a of the circuit board 3 more firmly. In addition, for the purpose of improving the similar advantages, it is preferable that the metal material having the large specific gravity such as SUS, SPC, aluminum, etc., for example, should be employed as the material of the cap 1b.

As described above, according to the BGA element 1 of the present embodiment, the bottom surface 10 of the BGA element 1 can be set in parallel with the mounting surface 3a of the circuit board 3 after the solder-connection by the reflow process, and also the distance between the bottom surface 10 and the mounting surface 3a of the circuit board 3 can be defined uniformly by the supporting portions 14 without the influence of the melting characteristic of the solder balls 11 on the bottom surface 10 due to the variation of the environmental conditions, etc. Therefore, after the BGA element 1 is surface-mounted onto the circuit board 3, respective positions of the top ends 21a of the plugs 21 against the mounting surface 3a are set at the position that is defined previously before the BGA element 1 is surface-mounted. Here, the resist (not shown) maybe provided on the mounting surface 3a of the circuit board 3. In such case, it is preferable that the mounting surface 3a, which contacts to the supporting portions 14a of the supporting portions 14, should be removed by the thickness of the resist to be provided before the BGA element 1 is surface-mounted onto the circuit board 3. Accordingly, although the resist is provided, respective positions of the top ends 21a of the plugs 21 against the mounting surface 3a are not affected by the variation in thickness of the resist in the mounting surface 3a.

FIG. 3 is a sectional view of the state that the circuit board 3, onto which the BGA element 1 according to the present embodiment is surface-mounted, is connected to another circuit board 7, onto which another BGA element 5 is surface-mounted, via respective connector terminals of the BGA element 1 and another BGA element 5.

Another circuit board 7, onto which another BGA element 5 is surface-mounted, is obtained by partially modifying the structure of the circuit board 3, onto which the BGA element 1 is surface-mounted. The explanation of the common structures between another circuit board 7, onto which another BGA element 5 is surface-mounted, and the circuit board 3, onto which the BGA element 1 is surface-mounted, will be omitted herein. Different aspects of another circuit board 7, onto which another BGA element 5 is surface-mounted, from the circuit board 3, onto which the BGA element 1 is surface-mounted, are that the plugs 21 protruded from the upper surface 20 of the BGA element 1 are constructed by receptacles 61, which are protruded from an upper surface 60, in another circuit board 7 and that contact portions 65 are provided along at least two opposing sides of the upper surface 60 of another BGA element 5.

Also, since plural plugs 21 of the BGA element 1 and the corresponding receptacles 61 of another BGA element 5 are integrated at the high density respectively, a fitting length range 61a of the plug 21 into the receptacle 61 is restricted into 0.5 mm. Therefore, like the relationship between the top ends 21a of the plugs 21 of the BGA element 1 and the mounting surface 3a, respective middle points 61b of the fitting length ranges 61a of the receptacles 61 against a mounting surface 7a of another mounting board 7 after another BGA element 5 is surface-mounted onto the circuit board 7 are set at the position that is defined previously by supporting portions 54 before another BGA element 5 is surface-mounted onto another circuit board 7.

Respective contact portions 65 are provided to project in the direction along which the receptacles 61 are extended from the upper surface 60, and contact surfaces 65a that are in parallel with a bottom surface 50 are provided to their projected ends. Then, an interval 65b between the bottom surface 50 and respective contact surfaces 65a is defined such that the top ends 21a of plural plugs 21 can be positioned at the middle points 61b of the fitting length ranges 61a of the corresponding receptacles 61 and fitted thereto when respective contact surfaces 65a are brought into contact with the mounting surface 3a of the circuit board 3.

Therefore, in the circuit board 3 onto which the BGA element 1 is surface-mounted and another circuit board 7 onto which another BGA element 5 is surface-mounted, the top ends 21a of the plugs 21 are positioned at the middle points 61b of the fitting length ranges 61a of the receptacles 61, and also the contact surfaces 65a of the contact portions 65 come into contact with the mounting surface 3a. Then, another circuit board 7 is supported against the circuit board 3 via the supporting portions 54 of the BGA element 5, a main body portion 5a and the contact portions 65. Here, the resist (not shown) may be provided to the mounting surface 3a of the circuit board 3. In such case, it is preferable that the mounting surface 3a that contacts to the contact surfaces 65a of the contact portions 65 should be removed by the thickness of the resist to be provided before another BGA element 5 is brought into contact with the circuit board 3. Accordingly, although the resist is provided to the mounting surface 3a of the circuit board 3, the situation that the top ends 21a of the plugs 21, which are defined previously to be set at predetermined positions from the mounting surface 3a, can be positioned at the middle points 61b of the fitting length ranges 61a of the receptacles 61 is never affected by the variation in thickness of the resist in the mounting surface 3a.

In this state, the circuit board 3 and the circuit board 7 are fixed by fixing means (not shown) that are used to fix their mutual positions. According to the fixing means, an external force A that is almost perpendicular to the mounting surface 3a and acts to the circuit board 7 side is applied to the circuit board 3, and also an external force B that is almost perpendicular to the mounting surface 7a and acts to the circuit board 3 side is applied to the circuit board 7. Here, since the circuit board 7 is supported against the circuit board 3 via the supporting portions 54 of the BGA element 5, the main body portion 5a, and the contact portions 65, the external force A and the external force B are not directly applied to solder-connected portions between the BGA element 1 and the circuit board 3 and the fitted portions between the plugs 21 and the receptacles 61. Here, the contact portions 65 may be provided to not another BGA element 5 but the circuit board 3 or the circuit board 7, otherwise such contact portions 65 may be provided as separate components. In this case, the external force A and the external force B are not directly applied to solder-connected portions between another BGA element 5 and another circuit board 7. Also, since the circuit board 3 and the circuit board 7 are fixed by the above fixing means, the influence of an external force C on the solder-connected portions between the BGA element 1 and the circuit board 3, the solder-connected portions between another BGA element 5 and another circuit board 7, and the fitted portions between the plugs 21 and the receptacles 61 can be reduced even if the circuit board 3 or the circuit board 7 receives the external force C that acts in the direction being parallel with the mounting surface 3a of the circuit board 3 or the mounting surface 7a of the circuit board 7.

In addition, respective positions of the top ends 21a of the plugs 21 against the mounting surface 3a after the BGA element 1 is surface-mounted onto the circuit board 3 can be defined uniformly by the supporting portions 14 on the bottom surface 10 so that the top ends 21a are positioned on a flat surface, that is set previously in parallel with the mounting surface 3a of the circuit board 3 and have a predetermined distance from the mounting surface 3a, without the influence of the variation in the environmental conditions in the reflow process when the BGA element 1 is surface-mounted onto the circuit board 3. As a result, when another BGA element 5 that is coupled to the BGA element 1 is surface-mounted onto another circuit board 7, such mounting step can be carried out independently from the step, by which the BGA element 1 is surface-mounted onto the circuit board 3, by referring to the distance from the mounting surface 3a to the top ends 21a of the plugs 21, which is defined previously by the supporting portions 14 of the BGA element 1.

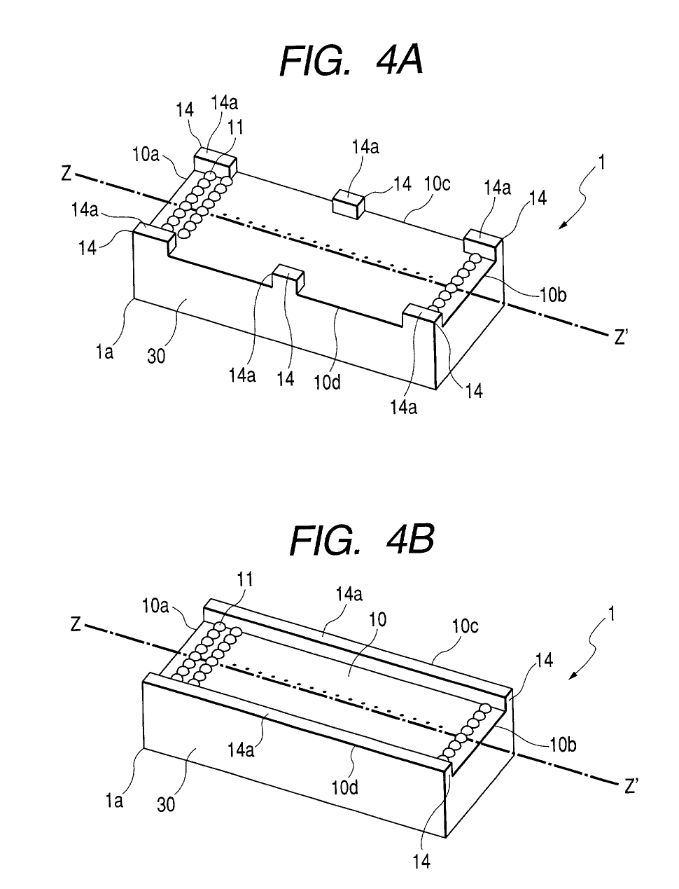

In the BGA element 1 according to the present embodiment, the supporting portions 14 are provided to four corners of the bottom surface 10 respectively. In this case, as shown in FIG. 4A, the supporting portion 14 may be provided to at least any one position of middle positions between four corners, in addition to the provision of the supporting portions 14 to four corners of the bottom surface 10 respectively. As shown in FIG. 4B, the supporting portions 14 may be provided along sides 10c, 10d as long sides of the bottom surface 10. These are matters that may be decided appropriately with regard to the shape of the main body portion 1a of the BGA element 1. In the case of FIG. 4B, such supporting portions 14 are effective to set the mounting surface 3a in parallel with the bottom surface 10 in the direction of the sides 10c, 10d serving as the long sides. In addition, the supporting portions 14 maybe provided as the individual components that are prepared independently from the BGA element 1. In this case, the design change of the supporting portions 14 can be executed independently from the main body portion 1a. Further, although the supporting portions 14 are provided to the bottom surface 10 in the explanation of the present embodiment, such supporting portions 14 may be provided to the side surfaces 30 that are located between the bottom surface 10 and the upper surface 20.

Also, in the present embodiment, the BGA element 1 has the male connector terminals constructed by plural plugs and another BGA element 5 has the female connector terminals constructed by plural receptacles. However, the BGA element 1 may be constructed to have the female connector terminals constructed by plural receptacles, while another BGA element 5 may be constructed to have the male connector terminals constructed by plural plugs. In addition, in the present embodiment, the contact portions 65 are provided along at least two opposing sides of the upper surface 60 of another BGA element 5. However, such contact portions 65 may be provided to four corners of the upper surface 60 respectively, or may be provided along four sides of the upper surface 60 to surround plural receptacles 61 on the upper surface 60. In addition, the contact portions 65 may be provided to the side surfaces 30 located between the bottom surface 10 and the upper surface 20. Also, the contact portions 65 are provided to another BGA element 5 that has a plurality of receptacles 61, but such contact portions may be provided to the upper surface 20 of the BGA element 1 that has a plurality of plugs 21.

Next, an embodiment of an optical communication module using the BGA element according to the present invention will be explained hereunder.

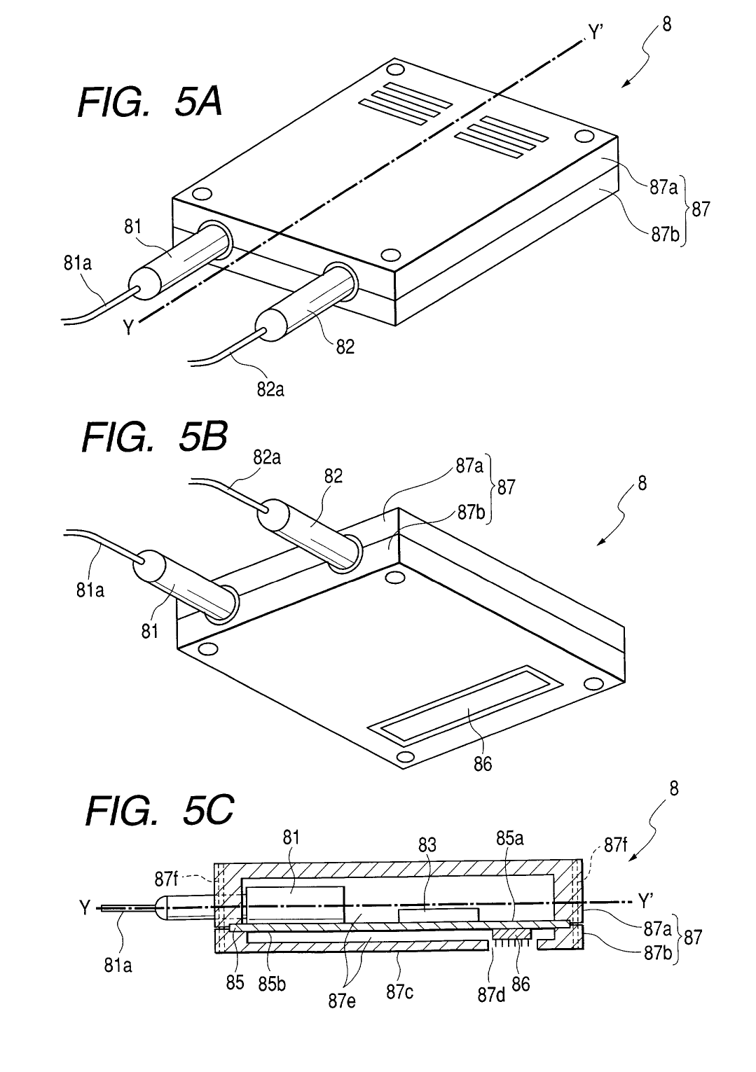

FIG. 5A shows a perspective view, viewed obliquely from the top, of an optical communication module 8 using the BGA element according to the present invention. FIG. 5B shows a perspective view, viewed obliquely from the bottom, of the optical communication module 8 using the BGA element according to the present invention. FIG. 5C shows a sectional view of the optical communication module 8 using the BGA element according to the present invention taken along a Y-Y′ direction in FIG. 5A.

The optical communication module 8 has a light transmitting module 81, a light receiving module 82, a semiconductor circuit element 83 for synthesizing a driving signal (referred to as a “driving circuit element 83” hereinafter), a semiconductor circuit element for separating a received signal (not shown, and referred to as a “receiving circuit element” hereinafter), a circuit board 85, a BGA element 86 explained in the above embodiment, and a housing 87. Also, the light transmitting module 81 and the light receiving module 82 have optical waveguide means 81a, 82a, which are optically connected to an optical transmission line (not shown), respectively.

The circuit board 85 has a board upper surface 85a and a lower surface 85b that is opposed in parallel to this upper surface 85a. The light transmitting module 81, the light receiving module 82, the driving circuit element 83, and the receiving circuit element are mounted onto the board upper surface 85a.

A plurality of pads that correspond to plural solder balls of the BGA element 86 are provided to the lower surface 85b, and the BGA element 86 having the male connector terminals constructed by plural plugs is surface-mounted onto the lower surface 85b. Then, the circuit board 85 has circuit wirings (not shown) for connecting the light transmitting module 81, the driving circuit element 83, which are mounted onto the board upper surface 85a, and the BGA element 86, and circuit wirings (not shown) for connecting the light receiving module 82, the receiving circuit element, and the BGA element 86.

The housing 87 includes a housing upper portion 87a and a housing lower portion 87b. When the housing upper portion 87a and the housing lower portion 87b are combined together, a space 87e in which the circuit board 85 on which the light transmitting module 81, the light receiving module 82, the driving circuit element 83, the receiving circuit element, and the BGA element 86 are mounted is installed is defined. The circuit board 85 is fixed to be contained in the housing 87, and also the housing lower portion 87b has a housing bottom surface 87c that becomes parallel with the lower surface 85b of the circuit board 85 that is fixed in the housing 87. Also, an opening portion 87d through which the BGA element 86 contained in the housing 87 is fitted into the external device outside of the housing 87 is provided in a part of the housing bottom surface 87c.

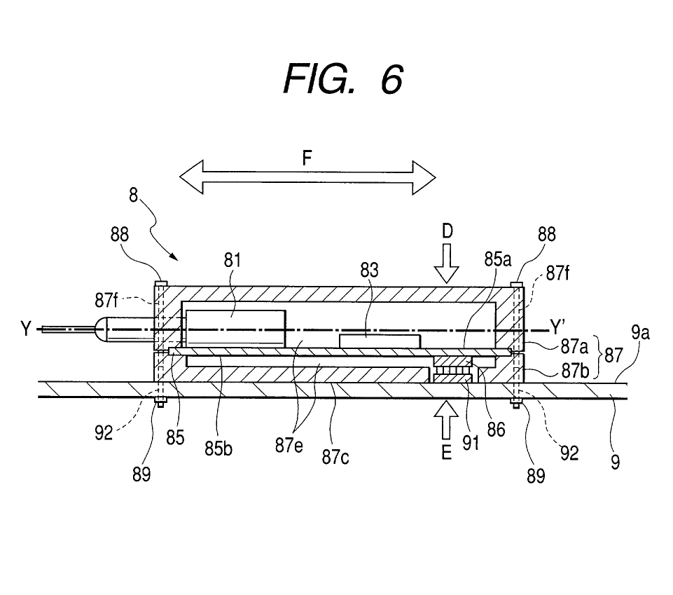

Now, functions of the optical communication module 8 will be explained simply hereunder. The BGA element 86 functions as an input/output terminal of electric signals in the optical communication module 8. Then, a plurality of electric signals having signal components are input simultaneously to the optical communication module 8 via the BGA element. A plurality of electric signals being input are synthesized into an electric signal by the driving circuit element 83 and then supplied to the light transmitting module 81. Then, the light transmitting module 81 converts the electric signal into a light signal in response to the signal components synthesized into one electric signal, and then sends out the light signal to the optical transmission line via the optical waveguide means 81a. In contrast, the light signal that is transmitted from the optical transmission line via the optical waveguide means 82a is received by the light receiving module 82 and supplied to the receiving circuit element as one electric signal in response to the signal components of the light signal. The signal components of the electric signal being supplied are separated into plural electric signals by the receiving circuit element, and the plural electric signals are output to the outside of the optical communication module 8 via the BGA element at the same time. The optical communication module 8 is mounted on the mounting board 9 (FIG. 6) and is employed.

FIG. 6 is side sectional view of the state that the optical communication module 8 is mounted on the mounting board 9. The mounting board 9 has a mounting surface 9a, another BGA element 91, another electric element (not shown), and circuit wiring means (not shown). The optical communication module 8 is mounted on the mounting surface 9a. Another BGA element 91 has the female connector terminals consisting of plural receptacles, which are fitted onto the plugs of the BGA element 86 in the optical communication module 8, and described in the above embodiment. Another electric element transmits/receives the electric signal to/from the optical communication module 8 via another BGA element 91 and the BGA element 86. The circuit wiring means connects another BGA element 91 and another electric element. Then, an interval between the lower surface 85b of the circuit board 85 and the housing bottom surface 87c of the housing 87 is defined such that the top ends of plural plugs of the BGA element 86 can be positioned at the middle points of the fitting length ranges of the corresponding receptacles of another BGA element 91 and fitted thereto when the housing bottom surface 87c is brought into contact with the mounting surface 9a of the mounting board 9. Here, another BGA element 91 has the similar configuration to another BGA elements being explained in the above embodiments, but is different from another BGA elements being explained in the above embodiments only in that this another BGA element 91 does not have the contact portions.

Therefore, in the optical communication module 8 and the mounting board 9, the housing bottom surface 87c of the housing 87 comes into contact with the mounting surface 9a of the mounting board 9 in the situation that the top end portions of the plugs of the BGA element 86 are positioned at the middle points of the fitting length range of the receptacles of another BGA element 91. Then, the optical communication module 8 is supported by the housing 87 via the housing bottom surface 87c of the housing lower portion 87b against the mounting board 9.

In this state, in order to fix mutual positions of the optical communication module 8 and the mounting board 9, the optical communication module 8 has housing through holes 87f, which extend in the direction perpendicular to the housing bottom surface 87c, at four corners of the housing 87 respectively. Further, the mounting board 9 has mounting board through holes 92 at positions that correspond to the housing through holes 87f respectively. Therefore, the optical communication module 8 and the mounting board 9 are fixed by bolts 88, which are passed through the housing through holes 87f and the mounting board through holes 92, and nuts 89, which are fastened to the bolts 88. Now, if the housing through holes 87f are formed in the housing bottom surface 87c as screwed holes, the optical communication module 8 may be fixed to the mounting board 9 by the screws from the opposing side to the mounting surface 9a of the mounting board 9 via the mounting board through holes 92.

As a result, an external force D that is almost perpendicular to the mounting surface 9a of the mounting board 9 and acts to the mounting board 9 side is applied to the housing 87, whereas an external force E that is almost perpendicular to the mounting surface 9a and acts to the optical communication module 8 side is applied to the mounting board 9. Here, the optical communication module 8 is supported by the housing 87 via the housing bottom surface 87c. For this reason, the external force D and the external force E are not directly applied to the solder-connected portions between another BGA element 91 and the mounting board 9, the solder-connected portions between the BGA element 86 and the circuit board 85, and the fitted portions between plural plugs 21 of the BGA element 86 and the corresponding receptacles 61 of another BGA element 91. Also, since similarly the optical communication module 8 and the mounting board 9 are fixed mutually as described above, the influence of an external force F on the solder-connected portions between another BGA element 91 and the mounting board 9, the solder-connected portions between the BGA element 86 and the circuit board 85, and the fitted portions between plural plugs 21 of the BGA element 86 and the corresponding receptacles 61 of another BGA element 91 can be reduced even if the optical communication module 8 or the mounting board 9 receives the external force F that acts in the direction being parallel with the mounting surface 9a of the mounting board 9.

Further, respective positions of the top ends of plural plugs against the lower surface 85b after the BGA element 86 is surface-mounted onto the circuit board 85 can be defined uniformly by the supporting portions of the BGA element 86 so that the top ends of plural plugs are positioned on the flat surface, which is set previously in parallel with the lower surface 85b of the circuit board 85 and have a predetermined distance from the lower surface 85b, without the influence of the variation in the environmental conditions in the reflow process when the BGA element 86 is surface-mounted onto the circuit board 85. As a result, the surface-mounting of another BGA element 91 that is coupled to the BGA element 86 onto the mounting board 9 on which the optical communication module 8 is mounted can be carried out independently from the surface-mounting of the BGA element 86 onto the circuit board 85, by referring to the distance from the lower surface 85b to the top ends of the plugs, which is defined previously by the supporting portions of the BGA element 86.

As described above, according to the optical communication module that has the BGA element as the input/output terminal of the electric signal os the present invention, the mounting board, which has another BGA element that is fitted to the BGA element and drive the mounted optical communication module, can be manufactured, independently from the manufacture of the optical communication module individually.

In the present embodiment, the structure having the light transmitting module 81 and the light receiving module 82 is employed. However, if the optical communication module is constructed by at least one light transmitting module 81 or at least one light receiving module 82, it is apparent that such structure is within the scope in which the advantages of the present invention can be achieved.

As described in detail above, according to the BGA element of the present invention, the interval between the connector terminals of the BGA element and the mounting surface on which the BGA element is surface-mounted can be set at the position, which is defined previously by the supporting portions provided to the BGA element before the BGA element is surface-mounted, without the influence of the change of the environmental conditions in the surface-mounting. Therefore, the manufacture of another BGA element, that comes into contact with the mounting surface on which the BGA element is surface-mounted to define the fitting length into the BGA element, can be carried out independently from the surface-mounting of the BGA element, by referring to the interval between the connector terminals of the BGA element and the mounting surface, which is defined by the supporting portions provided to the BGA element.

What is claimed is:

1. A ball grid array element comprising:
a main body portion having a bottom surface and an upper surface opposed to the bottom surface, the bottom surface having a ball grid array including a plurality of solder balls thereon, the upper surface having connector terminals connected respectively individually to the solder balls thereon; and
a supporting portion for defining an interval between said ball grid array element and a mounting surface on which said ball grid array element is surface-mounted, the supporting portion being brought into contact with the mounting surface when said ball grid array element is surface-mounted.

2. The ball grid array element according to claim 1, wherein the connector terminals includes one of a plurality of plugs and a plurality of receptacles.

3. The ball grid array element according to claim 1, further comprising:
a contact portion for defining a fitting length range of the connector terminals of said ball grid array element and another connector terminals of another ball grid array element to be connected to said ball grid array element, the contact portion being brought into contact with another mounting surface on which another ball grid array element is surface-mounted when said ball grid array element is connected to another ball grid array element.

4. The ball grid array element according to claim 3, wherein the connector terminals of said ball grid array element includes one of a plurality of plugs and a plurality of receptacles, and wherein another connector terminals of another ball grid array element includes the other of a plurality of plugs and a plurality of receptacles.

5. The ball grid array element according to claim 1, wherein the main body portion has a rectangular parallelepiped shape, and wherein the supporting portion has four supporting parts provided at four corners of the bottom surface.

6. The ball grid array element according to claim 5, wherein the supporting portion has further at least one supporting part provided at least any one position of middle positions between four corners of the bottom surface.

7. The ball grid array element according to claim 1, wherein the main body portion has a rectangular parallelepiped shape, and wherein the supporting portion has two supporting parts provided along long sides of the bottom surface.

8. The ball grid array element according to claim 1, wherein the supporting portion projects in a direction along which the connector terminals are extended from the upper surface, and has a supporting surface provided at projected end thereof, the supporting surface being parallel with the bottom surface, and wherein the supporting surface is brought into contact with the mounting surface when said ball grid array element is surface-mounted.

9. The ball grid array element according to claim 1, further comprising:
a cap for protecting the connector terminals, the cap having a temporarily-fixing member which can be attached to or detached from the main body portion.

10. The ball grid array element according to claim 1, wherein top ends of the connector terminals are positioned on a plane that is in parallel with the bottom surface.

11. The ball grid array element according to claim 3, the contact portion projects in a direction along which the connector terminals are extended from the upper surface, and has a contact surface provided at projected end thereof, the contact surface being parallel with the bottom surface, and wherein the contact surface is brought into contact with another mounting surface when said ball grid array element is connected to another ball grid array element.

12. The ball grid array element according to claim 3, wherein the main body portion has a rectangular parallelepiped shape, and wherein the contact portion has two contact parts provided along at least two opposing sides of the upper surface.

13. An optical communication module comprising:
at least one of a light transmitting module and a light receiving module;
at least one semiconductor circuit element used for at least one of light transmitting module and the light receiving module;
a ball grid array element including a main body portion having a bottom surface and an upper surface opposed to the bottom surface, the bottom surface having a ball grid array including a plurality of solder balls thereon, the upper surface having connector terminals connected respectively individually to the solder balls thereon, and a supporting portion for defining an interval between said ball grid array element and a mounting surface on which said ball grid array element is surface-mounted, the supporting portion being brought into contact with the mounting surface when the ball grid array element is surface-mounted;
a circuit board on which at least one of the light transmitting module and the light receiving module, at least one semiconductor circuit element, and the ball grid array element are provided; and
a housing for containing the circuit board.

14. The optical communication module according to claim 13, wherein the housing has a housing bottom surface which is brought into contact with another mounting surface on which another ball grid array element having another connector terminals is surface-mounted when said optical communication module is mounted on another mounting surface.

15. The optical communication module according to claim 14, wherein the connector terminals of said ball grid array element includes one of a plurality of plugs and a plurality of receptacles, and wherein another connector terminals of another ball grid array element includes the other of a plurality of plugs and a plurality of receptacles.

16. The optical communication module according to claim 14, wherein the housing bottom surface is provided to be parallel with the bottom surface of the ball grid array element.
